(19) United States
(12) Patent Application Publication
(10) Pub. No.: US 2016/0052614 A1
(43) Pub. Date: Feb. 25, 2016

(54) VARIABLE BUOYANCY LIGHTER THAN AIR GLIDER

(71) Applicant: Aether Industries, LLC., Pasadena, CA (US)

(72) Inventors: Benjamin Wesley Longmier, Pasadena, CA (US); John Mark Guthery, Del Valle, TX (US); John Patrick Sheehan, Ann Arbor, MI (US); Benjamin Natan Wachs, San Francisco, CA (US)

(21) Appl. No.: 14/835,196

(22) Filed: Aug. 25, 2015

Related U.S. Application Data
(60) Provisional application No. 62/041,633, filed on Aug. 25, 2014.
(60) Provisional application No. 62/059,119, filed on Oct. 2, 2014.

(51) Int. Cl. B64B 1/02; G01W 1/08; G05D 1/04

(52) U.S. Cl. CPC B64B 1/02; G05D 1/042; G01W 1/08

(57) ABSTRACT

A payload delivery and recovery system, having a payload including a data collection device arranged to collect data, and a controllable ascent vehicle comprising a controllable lighter than air (LTA) mechanism detachably coupled to the payload and used during an ascent phase to deliver the payload to a pre-determined altitude. The payload delivery and recovery system also having a controllable descent mechanism releasably attached to the controllable ascent vehicle and that can be used during a descent phase for reducing a rate of descent of the payload subsequent to release of the payload at the pre-determined altitude and including a control system for navigating the payload to a desired ground location during a recovery phase.

### CROSS REFERENCE TO RELATED APPLICATIONS

The present application claims the benefit under 35 U.S.C. 119(e) of i) U.S. Provisional Application No. 62/041,633, entitled “VARIABLE BUOYANCY LIGHTER THAN AIR GLIDER,” filed Aug. 25, 2014, and ii) U.S. Provisional Application No. 62/059,119 entitled “LOW COST SUPERPRESSURE BALLOONS,” filed Oct. 2, 2014, the contents of which are incorporated herein by reference in their entirety for all purposes. The present application is also related to and incorporates by reference in its entirety for all purposes co-pending U.S. patent application titled, “ATMOSPHERIC DATA COLLECTION AND RECOVERY SYSTEM AND METHODS” by Longmier et. al. filed Jul. 17, 2015 having application Ser. No. 14/802,377.

### FIELD OF THE DESCRIBED EMBODIMENTS

The described embodiments generally relate to mechanisms for controlling the ascent and descent of a payload in the Earth's atmosphere. More specifically, embodiments relate to a buoyancy system for controlling ascent of a payload and guided descent apparatus including a control system for controlling descent of the payload.

### DESCRIPTION OF RELATED ART

Presently, data collection devices are floated above the Earth's surface to collect specific data. For example, balloons are used to suspend various devices and sensors above the surface of the Earth for collection of data for commercial use as well as for experimental and scientific research. One example is weather data collection where sensors are attached to a weather balloon, which is released into the Earth's atmosphere. The weather balloon rises above the Earth and the sensors record information.

Weather balloons are often made of latex, rise vertically from the Earth's surface into the atmosphere and pop after a period of time as the external air pressure decreases, causing the balloon to expand beyond the elastic limit of the balloon material. Accordingly, the resulting sensor and associated data collection path is generally along a vertical profile that is ultimately controlled by air currents and upper level winds, with respect to the Earth's surface, as the balloon ascends above the Earth. In order to preserve any collected data, the sensors or data collection device often fall back to the ground in a reduced velocity but otherwise generally uncontrolled descent.

### SUMMARY OF THE DESCRIBED EMBODIMENTS

Embodiments described herein can control the ascent and descent of a payload with respect to the Earth's. Ascent of payload can be controlled by controlling the buoyancy of the payload itself or a system to which the payload is connected. Additionally, descent can be controlled by guiding the payload toward a specific location.

A navigable lighter than air (LTA) glider arranged to actively navigate upper atmosphere winds is described. The LTA glider includes at least a controllable buoyancy inflatable airfoil arranged to provide lift and controllable directionality to the LTA glider that includes a control surface used to control airflow around the inflatable airfoil, the controlled airflow used to provide the controlled directionality, a positive buoyancy portion configured provide a positive buoyancy comprising a balloon envelope, and a negative buoyancy portion configured to provide a fixed and/or a variable negative buoyancy. The LTA glider also includes an active navigation system used to control the positive and negative buoyancy portions and the control surface such that the LTA glider is able to use the upper atmosphere winds to remain aloft at a desired float altitude and in proximity to a desired ground location. In an embodiment, the LTA glider is attached to a payload having a data collection device used to collect data associated with the desired ground location at the float altitude.

A method for controlling an atmospheric data collection and recovery system is described. The method is carried out during an ascent phase, using a navigable lighter than air (LTA) vehicle having variable buoyancy system suitable for varying an overall buoyancy of the LTA vehicle and a navigation system arranged to control a directionality of the LTA vehicle to navigate a payload having a data collection device to a pre-determined float altitude and a ground location for a duration of time suitable for collection of data. During a data collection phase, using the navigation system to maintain the LTA vehicle at the desired float altitude and ground location for the duration of time, and during a recovery phase, using the navigating system to control a descent of the LTA vehicle from the pre-determined float altitude to a recovery location.

Non-transient computer readable medium for storing computer code executable by a processor system for controlling an atmospheric data collection and recovery system includes (i) computer code for controllably navigating an ascent of a payload comprising a data collection device to a range of pre-determined altitude using a lighter than air (LTA) vehicle, (ii) computer code for deploying the payload at the range of pre-determined altitude and a ground location and collecting data, iii) computer code for navigating the LTA vehicle at the float altitude above the ground location for a period of time sufficient to collect the data, and (iii) computer code for controlling a descent of the LTA vehicle from the float altitude to a recovery location using a descent vehicle.

### BRIEF DESCRIPTION OF THE DRAWINGS

The invention will be readily understood by the following detailed description in conjunction with the accompanying drawings, wherein like reference numerals designate like structural elements, and in which:

FIG. 1 illustrates a payload delivery and recovery system in various operational phases in accordance with the described embodiments.

FIG. 2 shows a schematic of a payload delivery and recovery system in accordance with the described embodiments.

FIGS. 3A and 3B show an embodiment of a payload system above the Earth's surface in an ascent phase and a deployment phase respectively, in accordance with the described embodiments.

FIG. 4 shows an embodiment of a LTA glider in accordance with the described embodiments

FIG. 5 is flow chart illustrating steps for operating a payload delivery and recovery system in accordance with the described embodiments.

FIG. 6 shows an exemplary flight path of a payload.

FIG. 7 is a block diagram of an electronic device suitable for use with the described embodiments.

### DETAILED DESCRIPTION OF SELECTED EMBODIMENTS

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following description relates in general to a data acquisition system that uses a payload having a data collection device used to collect, and in some cases process, data. In one embodiment, the data collection device can be lofted above the surface of the Earth using, for example, an ascent vehicle. The ascent vehicle can take many forms. However, in the context of this discussion, the ascent vehicle can take the form of lighter than air (LTA) mechanisms and apparatuses that can be used to control the ascent of a payload in the atmosphere above the Earth's surface. It should be noted that LTA mechanisms and apparatuses can include, for example, balloons, dirigibles, and so forth and an ascent vehicle can be any device that is useful to transport the payload into the Earth's atmosphere. It should be noted that in general a LTA mechanism and apparatus, as a whole, has a density less than the volume of air that it displace and will therefore have a positive buoyancy (even though some individual subcomponents may be lighter or heavier than air). It should also be noted is that the mass of the payload can be kept to less than about 2 kg. In this way, when the LTA mechanism is in the form of a balloon, it can be classified as a “Light” unmanned free balloon per the International Civil Aviation Organization (ICAO) regulations.

In some embodiments, the payload can be a digital sensor or other data collection device. In one embodiment, the payload can be carried aloft by a high altitude balloon system and therefore can be capable of aerial imaging functions, telecommunications relay functions, or other functions normally associated with a satellite in space. Moreover, the payload can be designed for mass production at a low cost. A low cost payload can include for example, a printed circuit board (PCB) requiring only minimal post-production assembly. During an ascent phase, the payload can be carried aloft by a (high altitude) balloon system up to a fixed, or in some cases a variable, altitude so that the payload can carry out the pre-determined functions such as aerial imaging or telecommunication relay. The payload can operate over a period of time above a location on the ground like a city, state, country, or larger geographical area for example, as it is carried by the wind or other air currents (such as the jet stream).

In some embodiments, an ascent vehicle can take the form of a balloon system that includes one or more first balloons that provide positive buoyancy. These balloons can be filled with gases having a density less than air (such as helium) and be formed of a material such as latex. The balloons can also take the form of, zero-pressure balloons, super-pressure balloons or similar balloons. It should be noted that the positive buoyancy system can provide fixed or variable positive buoyancy. In addition the balloon system can include, one or more second balloons (such as a super pressure balloon) filled with one or more gases or liquids with a high vapor pressure that provides negative buoyancy to the balloon system. The negative buoyancy balloons can provide fixed or variable negative buoyancy to the system and can provide negative buoyancy at and above a chosen altitude. The amount of negative buoyancy can be determined by the volume of the negative buoyancy balloons and the initial quantity of gas or liquid within the negative buoyancy balloons. The negative buoyancy balloons can be constructed out of a high strength material and/or a plurality of high strength cords or tendons, which further increase the strength of the balloons and hence increases the working pressure within the balloons.

Navigation of the balloon system can be achieved by setting a launch location and a float altitude of the balloon system to utilize atmospheric air patterns. The desired altitude and location can be reached by configuring the balloon system with an appropriate buoyancy to reach and float at the desired altitude. The buoyancy can be dynamic or controllable through volume and/or pressure changes to the balloon system. The airflow patterns at one or more altitudes can be utilized to control a general lateral position of a balloon system to direct the balloon system in one or more desired directions. The buoyancy of the balloon system can be altered or controlled in flight to change altitudes to take advantage of different airflow patterns at different altitudes. The different air patterns can be navigated to maintain the balloon system within a general vicinity of a predetermined lateral path across the Earth surface and/or over a specific point or area.

Although the described embodiments relate to balloons for controlling ascent and navigation over the Earth's surface, ascent systems are not so limited and alternative configurations where buoyancy can be controlled within a system to control ascent of a payload into the atmosphere are also covered by this disclosure.

Regarding controlling the descent of a payload, embodiments of a descent vehicle described can be used to control the payload to traverse a desired course and/or return to a desired location after being elevated to altitude and released (or deployed) from the ascent vehicle. For example, in some embodiments the descent vehicle can be used to control the descent of the payload in time and space. For instance, if the data collection device is active during the descent phase, the descent vehicle can maintain the data collection device aloft, or slowly descend, in order to optimize the amount and nature of the collected data. In one embodiment, the descent vehicle can take the form of a payload-integrated glider, a para-glider, a parachute, and so on. In some embodiments, at the initiation of the descent phase, the payload can separate from a high altitude balloon system (either by a programmed or commanded termination) and return to a particular location on the Earth (ground or water).

In accordance with another embodiment, a lighter than air (LTA) vehicle system is described that can float at a fixed altitude, ascend or descend to new altitudes with a significant glide slope ratio. In this way, the LTA vehicle system can navigate over a fixed point or area on the ground such as an individual building, a city, a metro area, or a desired mapping location. The LTA vehicle system can include several components. The components can include, for example, a balloon envelope that provides a fixed or variable positive buoyancy. The balloon envelope can take many forms such as a latex helium balloon, a zero-pressure helium balloon, a super-pressure helium balloon, and so on. The components can also include another balloon envelope that can provide negative buoyancy (such as a super-pressure balloon filled with one or more of gases, or liquids with a high vapor pressure: air, nitrogen, SF₆, ammonia, butane, methane, 1,1-difluoroethane, 1,1,1-trifluoroethane, or 1,1,1,2-tetrafluoroethane, etc.). The negative buoyancy envelope can provide a fixed or variable negative buoyancy to the system. The negative buoyancy system can also include an air pump and relief valve that can be used to add air or remove air from the negative buoyancy super-pressure balloon at altitude that can act to increase or decrease the float altitude of the system as a whole. It should be noted that by changing altitude, different wind directions can be used for navigational purposes.

In the described embodiment, a payload can be carried to an altitude above the ground. The payload can be configured to perform many functions. For example, the payload can be configured to capture aerial images (infrared, visible, UV, or multispectral), perform telecommunications operations (the functions of a WiFi router or other telecommunications relays, at any RF spectrum or with a free-space optical communications system), perform signal intelligence (detect RF or optical signals from below), or perform other functions normally associated with the functions that an artificial satellite in space.

A sub-system can be used that provides a significant glide slope ratio to the overall system. In practice, this may be a parafoil parachute, rigid or inflatable airfoil or wing, or another device that provides some degree of lift and controllable directionality to the overall system so that active navigation within the winds aloft may be possible and such that active navigation over a point or area on the ground is possible.

It should be noted that the system can be considered a single integrated system or structure. In one embodiment, the integrated system can take on an appearance of an inflatable flying parafoil (or an inflatable flying wing) that is able to achieve a horizontal velocity as it ascends and descends in the atmosphere. The horizontal velocity may be used for transporting the vehicle to a new location or the horizontal velocity may be used for maintaining a position over a fixed point or area on the ground.

It should be noted that the system can be launched from a nearby or distant location on the ground in order to fly over a point or area on the ground. The balloon system may float at a fixed altitude and drift in the wind, ascend from one altitude to another altitude to achieve a zero or net horizontal glide, or descend from one altitude to another altitude to achieve a zero or net horizontal glide, or some combination therein. In some cases, the balloon system can be commanded to vary the ascent or descent rates so that the horizontal glide speed matches the wind speed (maintaining a position over the ground), or may be commanded to achieve a net horizontal speed in order to fly a specific pattern over the ground or transport itself to a new location over the ground.

By using this method of continuously gliding (ascending then descending then ascending, etc.), the system uses a small amount of stored energy to affect a large gain in navigational ability and/or ability to fight against the wind in order to maintain a desired ground coverage for imaging or telecomm applications. Using this method of altitude it is possible using a lighter than air vehicle with the ability to alter its buoyancy to achieve negative and positive altitude changes and achieve a net horizontal locomotion.

In some embodiments, the payload can be configured for reusable or disposable use. In an exemplary embodiment, the payload can be include a printed circuit board (PCB), and have the shape of an airplane or glider, with an attached airfoil made out of low density foam with flexible solar panels mounted on the airfoil. The PCB can include traces instead of wires along a length of the board for coupling control mechanisms, actuators, antenna for transmitting and receiving and other devices supported on or coupled directly or indirectly to the circuit board.

In some embodiments, the descent apparatus can include controls for directing the controlled descent of the payload on its own or after being released from the ascent vehicle. The controls can automatically assess and determine a landing location based on a present location, altitude, atmospheric conditions, rate of decent, speed, orientation, and other similar factors, and combinations thereof. In some embodiments the controls can determine a landing location based on one or more predefined possible landing locations. In some embodiments the controls can determine a landing location based on possible landing conditions as derived from one or more sensors, and/or cameras and/or pre-stored geographic descriptors of locations within range of the payload. In some embodiments the controls can receive direction from a remote location or user for determining the landing location.

In some embodiments, once at the landing location, the payload can send out an alert that includes an indication of a location to retrieve the payload. The alert can be audial or visual. The alert can be electronic. For example, the payload may include a tracker such that a remote user can determine the location of the payload. The payload, or a system configured to detect a tracker associated with the payload, can send out the alert. The alert can be an email, text, application alert, or other means of indicating to a user that the payload is ready for retrieval. The alert can be sent to specific one or more entities, locations, or individuals based on the landing location. The alert can be generic to a pre-stored entity, location, or individual once the payload has landed.

In an exemplary embodiment of an ascent and descent of a payload, the payload can be carried aloft by an ascent vehicle in the form of a balloon system to an altitude of about 110,000 ft. above sea level. The balloon system and payload drift in the wind for some duration of time. The payload performs its functions such as sending live telemetry data and capturing imagery data for mapping purposes, and then the payload is separated from the balloon system so that the payload can return to a known waypoint on the ground in an automated way. The payload can use a combination of battery power and power from solar panels to power the controlled descent.

It should be noted that at the operating altitudes for the described embodiment, a large amount of ground coverage can be achieved for telecommunications and imagery applications. While it is less ground coverage when compared to a satellite, it is more ground coverage than that of a typical manned or unmanned airplane. For example, at 100,000 ft., the described balloon systems and payload can have a ground coverage circle, for imagery applications for example, of about 1000-miles in diameter.

In some embodiments, the payload can include a gimbal system for supporting and orientating a functioning device, such as a camera, from the frame. The gimbal system can orient and direct the camera to a desired location on the ground. The gimbal system can include a locator, such as GPS or camera system for determining a location of the payload. In some embodiments, the gimbal system can include information about a desired location to direct the functioning device. The gimbal system can include one or more other systems, mechanisms, or sensors for detecting other attributes, such as altitude, speed, orientation, decent, atmospheric conditions and similar attributes. The system can then determine an orientation for the gimbal system or properly direct the camera at a desired location on the ground. The desired location can include one or more locations. The system can therefore direct the camera at the one or more locations in a sequential manner and determine the necessary orientation of the gimbal device between successive positions to account for payload movement. The sequential desired locations can be, for example, a desired pattern to observe an area, such as a grid pattern. This gimbal system is useful for achieving persistent coverage of a single point, or capturing multiple points on the ground, such as in a grid pattern, for mapping purposes. Likewise, the gimbal system can be used for pointing high gain radio frequency RF communications antennas or free space optical communications systems for balloon-to-ground, ground-to-balloon, or balloon-balloon communications or data transfer, for example.

It should be noted that while embodiments described relate to controlling ascent and descent of a payload above the atmosphere, this disclosure is also applicable to descent and ascent of a payload in water below the Earth's surface, given the similarities of buoyancy concepts between the atmosphere and the oceans and other bodies of water.

In some embodiments, the data collection device can be capable of being selectively operable during the ascent, descent and recovery phases. In some embodiments, the controllable LTA mechanisms can include a positive buoyancy portion and a negative buoyancy portion. In some embodiments, the positive and negative buoyancy portions can each be balloons that can each be coupled together by a tether. In some embodiments, the positive buoyancy balloon can be a latex balloon filled with helium and the negative buoyancy balloon can be a super-pressure balloon filled with an amount of air, gas, or liquid to provide the negative buoyancy above a desired altitude.

In some embodiments, the ascent vehicle can be configured to ascend to a pre-determined range of altitude by taking advantage of wind patterns to position the payload system relative to corresponding surface location on the ground. In some embodiments, the payload can include a data-acquiring device. In some embodiments, the payload determines a landing location based on conditions detected by the data-acquiring device and/or pre-stored geographic descriptors of locations within range of the payload. In some embodiments, the payload can be a camera arranged to acquire images of pre-selected locations on a surface of the Earth. In some embodiments, the payload can include a wireless transceiver capable of wireless transmission of data and/or wireless reception of commands and/or data.

In some embodiments the LTA ascent vehicle can include a processor used for executing the (i) computer code for navigating the payload. In some embodiments the payload can include a processor used for executing the (ii) computer code for deploying and collecting data. In some embodiments the descent vehicle can include a processor used for executing the (iii) computer code for controlling the descent of the payload. In some embodiments the LTA ascent vehicle can include a positive buoyancy balloon and a negative buoyancy balloon each having a buoyancy adjustment system being controllable by the (i) computer code for navigating the ascent of the payload.

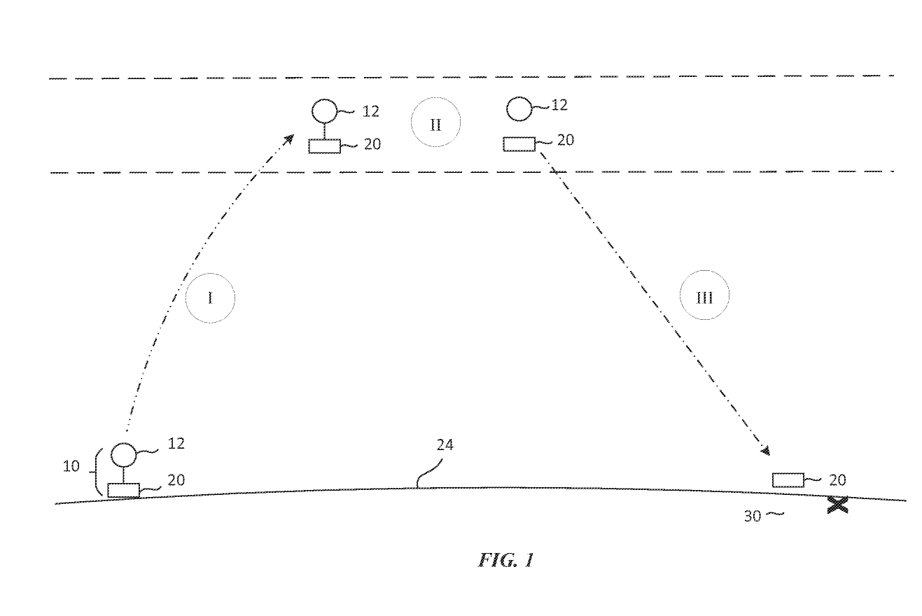

These and other embodiments are discussed below with reference to FIGS. 1-8. However, those skilled in the art will readily appreciate that the detailed description herein with respect to these figures is for explanatory purposes only and should not be construed as limiting.

FIG. 1 illustrates a payload system in various operational phases in accordance with the described embodiments. Payload system 10 can include an ascent vehicle that in this particular embodiment takes the form of LTA mechanism 12 attached to payload 20. LTA mechanism 12 can be a balloon, dirigible, or any other mechanism having a composition of components that combine to have an overall density less than an amount of displaced air and is therefore lighter than the displaced air at a given point in the Earth's atmosphere such that the altitude of LTA mechanism 12 can be controlled by buoyancy of LTA mechanism 12. In ascent phase I, the overall positive buoyancy of LTA mechanism 12 causes payload system 10 to rise off of the Earth's surface 24 and rise into the atmosphere until a desired altitude is reached. Once the desired altitude is reached, in a deployment phase II, payload 20 is deployed from the LTA mechanism 12. Deploying the payload 20 can be done by payload 20 separating from LTA mechanism 12. Separation can be initiated by LTA mechanism 12 or by the payload 20. It is also possible that the LTA mechanism 12 is integrated within the payload 20 and as such does not become separated from the LTA mechanism 12.

After payload 20 has been deployed, the payload 20, by way of a descent mechanism, described further below in various embodiments, can guide the payload down toward a desired landing site 30 in a recovery phase III. Data collection and transmission can occur during any or all of the phases described. Data can be transmitted during any of the operational phases by way of remote transmission or data can be physical collected by recovering the payload 20 from the landing site 30 and downloading the data.

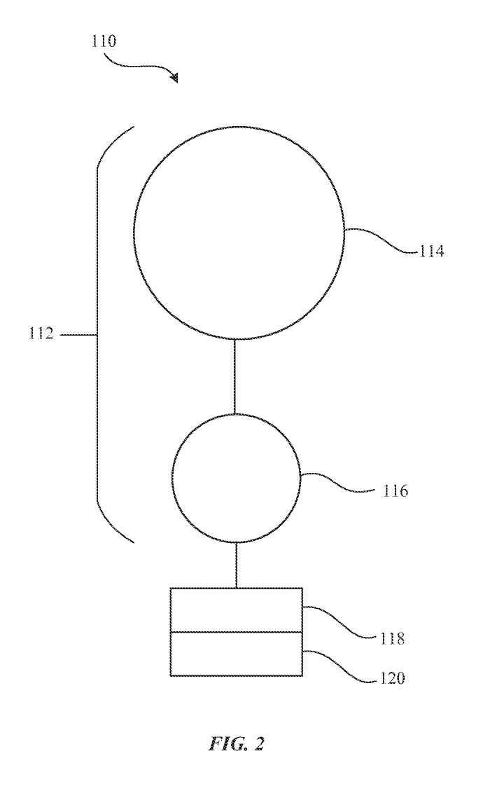

The LTA mechanism, descent mechanism and payload described above can take many forms. FIG. 2 illustrates a schematic of an embodiment of payload system 110 in accordance with the described embodiments. Payload system 110 can be formed of lighter than air (LTA) vehicle system 112, which is made up of a positive buoyancy portion 114 and a negative buoyancy portion 116. Positive buoyancy portion 114 can take the form of a balloon envelope in the form of a latex helium balloon, a zero-pressure helium balloon, a super-pressure helium balloon, and so on. The negative buoyancy portion 116 can on the other hand include such components as a super-pressure balloon filled with one or more of gases, or liquids with a high vapor pressure: air, nitrogen, SF₆, ammonia, butane, methane, 1,1-difluoroethane, 1,1,1-trifluoroethane, or 1,1,1,2-tetrafluoroethane, etc. Payload system 110 also includes a payload 120 that is coupled to the LTA vehicle system 112. The payload 120 can be directly coupled with LTA vehicle system 112 or by way of a descent mechanism 118, as shown. Since payload 120 is coupled to the LTA vehicle system 112, when the payload system 110 is launched, the buoyancy of the LTA vehicle system 112 controls the ascent of the payload system 110, during an ascent phase, carrying the payload 120 to a desired altitude. The negative buoyancy system can provide a fixed or variable negative buoyancy to the system. The negative buoyancy system can also include an air pump and relief valve that can be used to add air or remove air from the negative buoyancy super-pressure balloon at altitude that can act to increase or decrease the float altitude of the system as a whole. It should be noted that by changing altitude, different wind directions can be used for navigational purposes. The positive buoyancy portion 114 and negative buoyancy portion 116 of the LTA vehicle system 112 can be coupled together in any number of configurations. For instance, a tether such as a string, wire or cord, can connect the portions. The portions can also be conjoined, integrated within one another, such as one balloon being located inside the other, or combined in any number of other ways. It should be noted that LTA vehicle system 112 can float at a fixed altitude, ascend or descend to new altitudes with a significant glide slope ratio. In this way, LTA vehicle system 112 can navigate over a fixed point or area on the ground such as an individual building, a city, a metro area, or a desired mapping location. LTA vehicle system 112 can include several components.

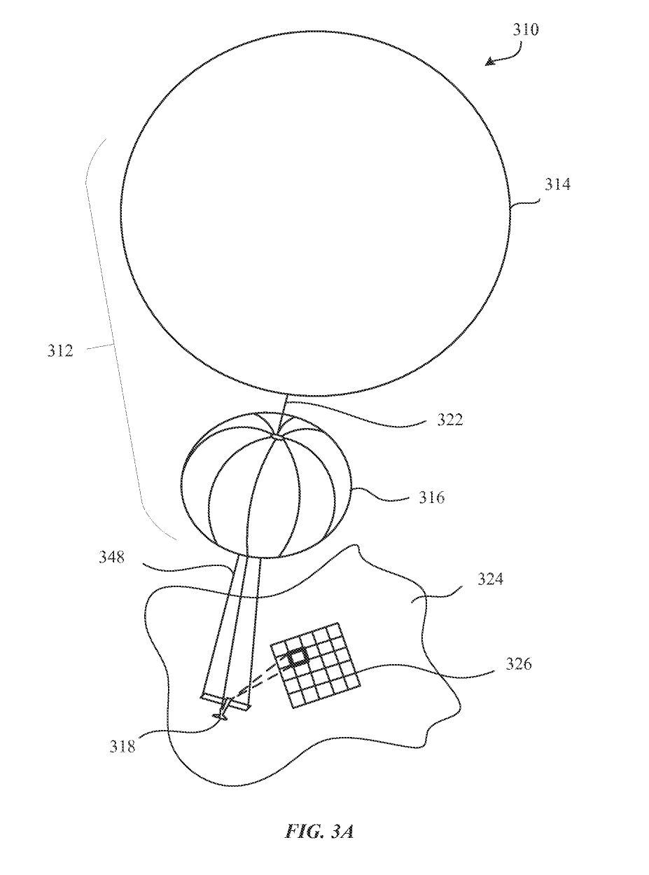

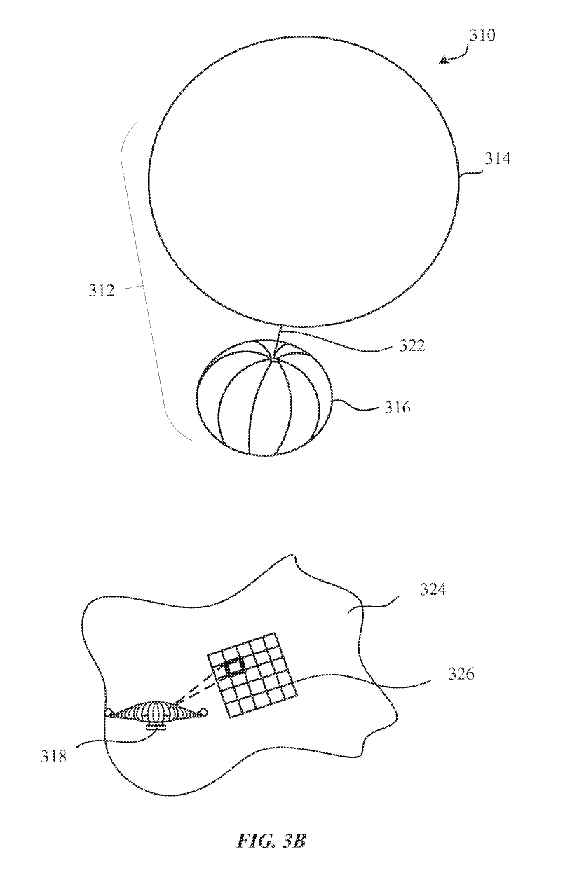

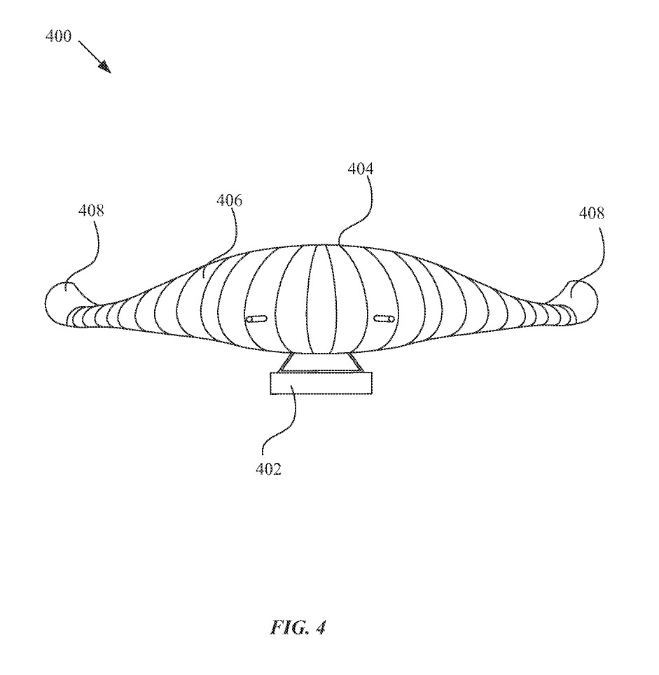

FIGS. 3A and 3B illustrate one embodiment of a payload system 310 shown at altitude over the Earth's surface 324, in accordance with the described embodiments. FIG. 3A shows the payload system 310 in the ascent phase as it rises to a desired altitude in the atmosphere and FIG. 3B shows a descent mechanism 318 (which is coupled to a payload illustrated in FIG. 4 and described further blew) of payload system 310, in a deployed state during the deployment phase.

FIG. 3A shows payload system 310 including a lighter than air (LTA) mechanism 312, that includes (high pressure) positive buoyancy balloon 314 and (super pressure) negative buoyancy balloon 316. It should be noted that although balloons 314 and 316 are shown as having a spherical or spheroidal shape, any shape is suitable. For example, balloons 314 and/or 316 can have a tear drop shape, a cylindrical shape, and so on. Descent mechanism 318 can be tethered to the negative buoyancy balloon 316 of the LTA mechanism 312 by three payload tethers 348. In FIG. 3B descent mechanism 318, is illustrated detached or deployed from LTA mechanism 312.

With regard to the LTA mechanism 312, negative buoyancy balloon 316 is tethered to positive buoyancy balloon 314 by way of a balloon tether 322. Descent mechanism 318 takes the form of a glider, which acts to control the descent of payload 320. As seen in FIG. 4, payload 320 is coupled to descent mechanism 318 and in one embodiment, payload 320 uses a gimbal system to point the data collection device (such as a camera) at multiple locations on the ground 324 using, for example, a grid pattern 326 to take high-resolution images.

It should be noted that positive buoyancy balloon 314 can be formed of many strong and lightweight materials and filled with gases having a density less than a corresponding volume of air. Positive buoyancy balloon 314 can be filled with a liquid or gas composition that can provide positive buoyancy. For example, a lightweight and strong material can be latex and the filler gas can be helium or hydrogen (helium is preferred due to the inert nature of helium as opposed to the flammability of hydrogen). Accordingly, positive buoyancy balloon 314 can take the form of latex helium balloon, zero-pressure helium balloon, super-pressure helium balloon or similar balloon configurations. Negative buoyancy balloon 316 can be a super-pressure balloon filled with one or more of gases, or liquids with a high vapor pressure such as air, nitrogen, SF₆, ammonia, butane, methane, 1,1-difluoroethane, 1,1,1-trifluoroethane, or 1,1,1,2-tetrafluoroethane or other composition that can provide fixed or variable negative buoyancy.

Super-pressure refers to having a pressure greater inside a super-pressure balloon than outside the balloon and zero-pressure refers to the pressure inside of a balloon being the same as the pressure outside of the balloon. Super-pressure balloons can be composed of a low-stretch material, plastic sheeting, polyethylene, Mylar, PVC, rip-stop nylon, or other similar material. The positive buoyancy balloon 314 and negative buoyancy balloon 316 can individually be fixed or variable volume. That is to say, they can be stretchy latex type balloons or fixed volume balloons. The latex balloons can be unmodified or have an interior coating of a liquid polymer to reduce helium diffusion, which increases the aloft lifetime of the balloon. Super-pressure balloons can have strings, cords, or tendons around the circumference in order to increase the total burst strength of the balloon, and hence increase the burst pressure of the balloon. All the balloons are preferably made of biodegradable or environmentally friendly materials.

Prior to launch, the negative buoyancy super-pressure balloon 316 can be filled with a known amount of air, or other gas, or liquid with a high vapor pressure, in order to select the altitude at which the negative buoyancy balloon 316 will go super-pressure, or in other words, when the pressure inside of the balloon exceeds the pressure outside of the balloon. When the negative buoyancy balloon 316 balloon goes super-pressure, it then starts providing negative buoyancy to the overall LTA mechanism 312 where gravity pulls the payload system 310 back down towards the Earth's surface to a lower altitude. Additional control of the altitude position of LTA mechanism 312 can be accomplished by utilizing air pumps and relief valves (not shown), which can be used to add gas or remove gas from the negative buoyancy balloon 316 while at altitude. This increases or decreases the float altitude of the payload system 310 as a whole. By changing altitude, different wind directions can be chosen for navigational purposes.

FIG. 4 shows a top perspective view of one embodiment of an integrated system configured as inflatable flying parafoil 400 in accordance with the described embodiments. In one embodiment, inflatable flying parafoil 400 (or an inflatable flying wing) is able to achieve a horizontal velocity as it ascends and descends in the atmosphere. The horizontal velocity may be used for transporting the vehicle to a new location or the horizontal velocity may be used for maintaining a position over a fixed point or area on the ground. It should be noted that the system can be launched from a nearby or distant location on the ground in order to fly over a point or area on the ground. Parafoil 400 may float at a fixed altitude and drift in the wind, ascend from one altitude to another altitude to achieve a zero or net horizontal glide, or descend from one altitude to another altitude to achieve a zero or net horizontal glide, or some combination therein. In some cases, parafoil 400 can be commanded to vary the ascent or descent rates so that the horizontal glide speed matches the wind speed (maintaining a position over the ground), or may be commanded to achieve a net horizontal speed in order to fly a specific pattern over the ground or transport itself to a new location over the ground. By using this method of continuously gliding (ascending then descending then ascending, etc.), parafoil 400 uses a small amount of stored energy to affect a large gain in navigational ability and/or ability to fight against the wind in order to maintain a desired ground coverage for imaging or telecomm applications.

In one embodiment, parafoil 400 can include solar panels for providing power for navigation and/or payload 402. Body 404 can be composed inflatable portions 406 and various control surfaces 408 (such as a tail with a rudder and elevators) used for controlling ascent and descent of parafoil 400 after deployment. Power for payload 402 and payload electronics and controls can be provided by a battery (not shown) or by solar panels (not shown) or by other similar means. Control of parafoil 400 can be pre-programmed or performed remotely. Parafoil 400 can be guided in a particular direction for descent toward a landing location. Payload 402 can have a multiple axis gimbal system in order to point a camera, high gain radio frequency (RF) antenna, or free-space-optical communications system in various directions for data collection and or guidance of parafoil 400 during a descent phase.

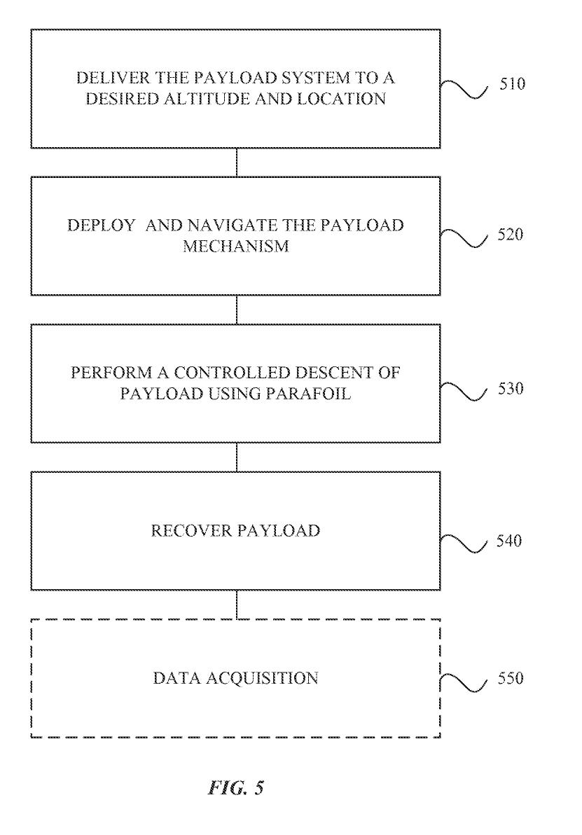

FIG. 5 is flow chart illustrating steps for operating a payload system in accordance with the described embodiments. The steps are described in relation to the embodiment shown in FIGS. 3A, 3B and 4. In operation, descent mechanism 318 is tethered to LTA mechanism 312. A desired altitude is selected given atmospheric wind patterns for locating payload 320 at a particular altitude and location for collecting the particular data desired. The buoyancy of LTA mechanism 312 is calculated for the desired altitude and is used to determine the appropriate buoyancy of each positive buoyancy balloon 314 and negative buoyancy balloon 316. The appropriate gases and/or liquids are filled into each respective balloon. It should be noted that glider 318 and payload 320 can be attached to the LTA mechanism 312 at any point prior to launch of the payload system. The payload system is launched and then delivered in an initial step 510 into the atmosphere, beginning an ascent phase, and where payload system 310 controllably rises up to its desired location carrying the glider 318 and payload. Once payload system 310 is at its desired altitude, changes to the altitude can be made to the payload system 310 by remote control or pre-programmed instructions, by modifying the buoyancy of negative buoyancy balloon 316, for example, using the air pumps and relief valves.

After the ascent phase, glider 318, which is the descent mechanism, can be deployed from the LTA mechanism 312, in a subsequent step 520. Then in a descent phase glider 318, utilizing the configuration of descent mechanism 318 and onboard controls and power systems, can descend with a reduced the rate of descent in a subsequent step 530. Descent mechanism/glider 318 can then be guided remotely or by pre-programmed instructions toward a desired landing site delivering the payload 320 for recovery, in a subsequent step 540. In addition to remote control or pre-programming glider 318 can determine a landing site based on real-time calculations made by the payload 320. While glider 320 is shown and described, other descent mechanisms are conceivable, including parachute, parafoil, powered unmanned aerial vehicle (UAV) and other similar devices.

In some embodiments, the descent to the ground can be such that the payload lands back at the launch location if the payload has enough range to do so. If, however, the LTA mechanism and payload system drifts farther downwind from the launch location than glide range of the payload, the payload can make a decision to land instead at one of a number of pre-designated landing locations. These multiple pre-programmed alternate landing locations can be single points on the ground or entire swaths or regions of land, which are defined at the time of programming the payload in the lab. Alternatively, the payload could receive updated landing location sites or zones via communications from the ground or satellite relay. Real time decision making capability may be built into the payload system such that on descent, the payload is continuously calculating the glide range based on its current location, air speed, ground speed, wind direction, etc. A real-time and automated decision can be made onboard the glider for calculating the best landing zone within glide distance.

A large number of safe landing zones can be defined around the US in order to foster participation on private lands, and a rewards based system can be implemented for setting up the landing zones. In one example, a farmer can be paid a nominal recovery fee for every glider payload that lands on his farm. Additionally, the farmer can agree to package up the glider and ship it back to a lab via a pre-paid mailing container.

In some embodiments the glider and payload are configured to be disassembled with simple tools or hands-only by a single person. A recovered glider that can be disassembled will result in parts that are a convenient size and shape designed to fit directly into pre-existing shipping boxes. One or more gliders can be collected during a given time period by a collector such as a rural farmer. As gliders land and/or accumulate, collectors may collect immediately as they see gliders land and/or are notified via electronic methods (a process which can be automated). Collection can take place daily or weekly and sped up on-demand based on a centralized logistical operations center at a remote location separate from the landing spot. The disassembled gliders can be directly shipped to a lab for refurbishment, shipped to another launch location or stored at their landing location which can also double as a launch location.

Recording of data, and in the exemplary embodiment, by way of digital camera 342, can take place in a subsequent step 560 or for the entire duration that the payload system 310 is in flight, or for any one or more phases of flight. High-resolution images can be collected by the gimbaled camera 342 or a non-gimbaled camera. When using an imaging device on an automated gimbal, aerial photos can be taken of the ground according to a pre-programmed set of coordinates. A wide-angle lens can be used to collect a large ground coverage area, or a telephoto lens is used to collect high-resolution images. When a telephoto lens is used, a pre-programmed grid pattern 326 is used to collect a large number of photos of the ground so that a known picture overlap is used and that very high-resolution mosaics can be made for mapping or GIS purposes. A telephoto lens can be used for collecting photos of the ground at nadir (down) or at a perspective angle. Perspective photos of the ground can be captured perpendicular to the flight path so that a large ground swath can be covered as the balloon system flies overhead.

The LTA mechanism can be configured to navigate over a desired location on the ground by choosing an appropriate launch location on the ground, and using knowledge of the atmospheric winds as a function of altitude to choose a fixed or variable altitude profile of the LTA vehicle. The float duration of the LTA vehicle may be any time increment from several minutes to several days or weeks.

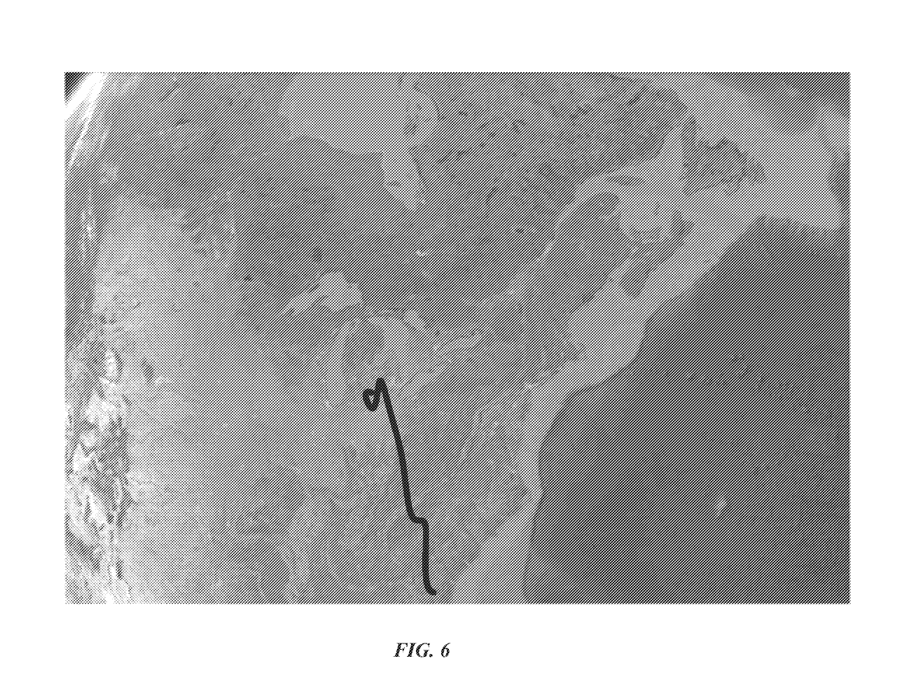

FIG. 6 shows an exemplary flight path of a payload being launched from near Ann Arbor, Mich., travelling through the Earth's atmosphere at a desired altitude taking advantage of atmospheric winds to move the payload in a particular direction and then descent and recovery of the payload around Alexandria, Va.

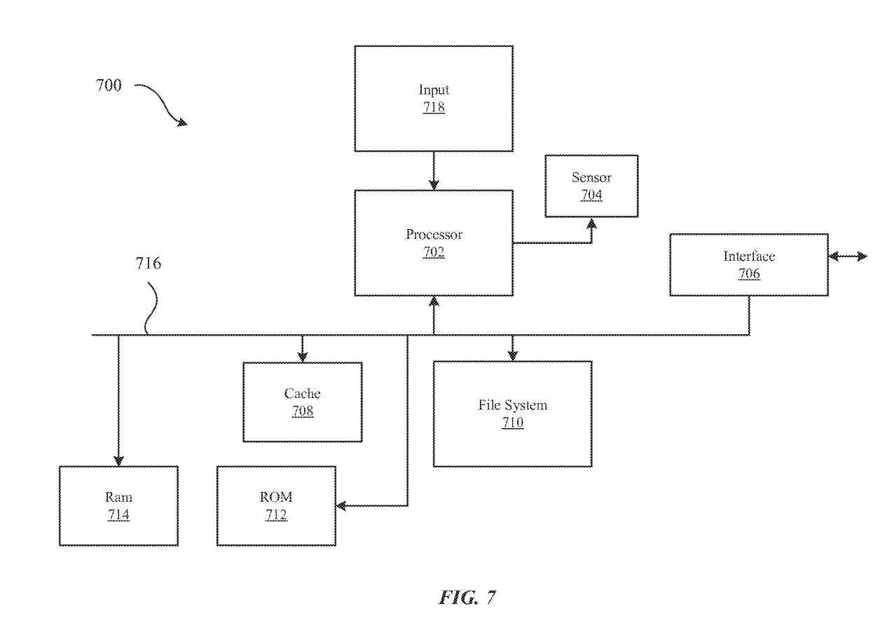

FIG. 7 is a block diagram of an electronic device 700 suitable for use with the described embodiments. The electronic device 700 illustrates circuitry of a representative computing device. The electronic device 700 includes a processor 702 that pertains to a microprocessor or controller for controlling the overall operation of the electronic device 700. The electronic device 700 stores media data pertaining to media items in a file system 710 and a cache 708. The file system 710 is, typically, a storage disk or a plurality of disks. The file system 710 typically provides high capacity storage capability for the electronic device 700. However, since the access time to the file system 710 is relatively slow, the electronic device 700 can also include a cache 708. The cache 708 is, for example, Random-Access Memory (RAM) provided by semiconductor memory. The relative access time to the cache 708 is substantially shorter than for the file system 710. However, the cache 708 does not have the large storage capacity of the file system 710. Further, the file system 710, when active, consumes more power than does the cache 708. The electronic device 700 can also include a RAM 714 and a Read-Only Memory (ROM) 712. The ROM 712 can store programs, utilities or processes to be executed in a non-volatile manner. The RAM 714 provides volatile data storage, such as for the cache 700.

The electronic device 700 also includes an interface 706 that couples to a data link 716. The data link 716 allows the electronic device 700 to couple to a host computer for data retrieval. The data link 716 can be provided over a wired connection or a wireless connection. In the case of a wireless connection, the interface 706 can include a wireless transceiver useful for real time data transmission.

A payload can be carried to an altitude above the ground in order to capture aerial images such as infrared, visible, UV, or multispectral, perform telecommunications operations, such as the functions of a Wi-Fi router or other telecommunications relays, at any RF spectrum or with a free-space optical communications system, perform signal intelligence such as detect RF or optical signals from below, or perform other functions normally associated with the functions of a satellite in space.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The computer readable medium is defined as any data storage device that can store data, which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

The invention claimed is:

1. A navigable lighter than air (LTA) glider arranged to actively navigate upper atmosphere winds, comprising:
a controllable buoyancy inflatable airfoil arranged to provide lift and controllable directionality to the LTA glider, comprising:
a control surface used to control airflow around the inflatable airfoil, the controlled airflow used to provide the controlled directionality,
a positive buoyancy portion configured provide a positive buoyancy comprising a balloon envelope,
a negative buoyancy portion configured to provide a fixed and/or a variable negative buoyancy, and
an active navigation system used to control the positive and negative buoyancy portions and the control surface such that the LTA glider is able to use the upper atmosphere winds to remain aloft at a desired float altitude and in proximity to a desired ground location; and
a payload comprising a data collection device, the payload being coupled to the LTA glider and used to collect data associated with the desired ground location at the float altitude.

2. The LTA glider of claim 1, wherein the data collection device is capable of being selectively operable during an ascent, a descent and a recovery phase.

3. The LTA glider of claim 2, wherein the positive buoyancy portion comprises a balloon filled with helium and wherein the negative buoyancy portion comprises a super-pressure balloon filled with an amount of air, gas, or liquid to provide the negative buoyancy above a desired altitude.

4. The LTA glider of claim 1 wherein during an ascent phase, the LTA glider ascends to a pre-determined range of altitude by taking advantage of wind patterns to position the payload relative to corresponding surface location on the ground.

5. The payload delivery and recovery system of claim 1, wherein active navigation system maintains the LTA glider at the desired float altitude by varying the positive and negative buoyancy portions and the control surface.

6. The LTA glider of claim 1, wherein the payload determines a landing location based on conditions detected by the data-acquiring device and/or pre-stored geographic descriptors of locations within range of the payload.

7. The LTA glider of claim 1, wherein the payload is a camera arranged to acquire images of pre-selected locations on a surface of the Earth.

8. The LTA glider of claim 1, wherein the camera is sensitive to light in the infra-red (IR) part of the spectrum.

9. The LTA glider of claim 3, wherein the super-pressure balloon holds one or more of gases, or liquids with a high vapor pressure: air, nitrogen, SF₆, ammonia, butane, methane, 1,1-difluoroethane, 1,1,1-trifluoroethane, or 1,1,1,2-tetrafluoroethane.

10. The LTA glider of claim 1, wherein the payload comprises a wireless transceiver capable of wireless transmission of data and/or wireless reception of commands and/or data.

11. A method for controlling an atmospheric data collection and recovery system, comprising:
during an ascent phase, using a navigable lighter than air (LTA) vehicle having variable buoyancy system suitable for varying an overall buoyancy of the LTA vehicle and a navigation system arranged to control a directionality of the LTA vehicle to navigate a payload comprising a data collection device to a pre-determined float altitude and a ground location for a duration of time suitable for collection of data;
during a data collection phase, using the navigation system to maintain the LTA vehicle at the desired float altitude and ground location for the duration of time using the variable buoyancy system; and
during a recovery phase, using the navigating system to control a descent of the LTA vehicle from the pre-determined float altitude to a recovery location.

12. The method as recited in claim 11, wherein the payload is attached to the navigable LTA vehicle.

13. The method as recited in claim 11, wherein the variable buoyancy system comprises a balloon system comprising a positive buoyancy balloon and a negative buoyancy balloon.

14. The method as recited in claim 11, further comprising: transmitting collected data during the data collection phase and/or the recovery phase.

15. The method as recited in claim 11, wherein the navigable LTA vehicle and/or the controllable descent vehicle is/are self-controlled.

16. Non-transient computer readable medium for storing computer code executable by a processor system for controlling an atmospheric data collection and recovery system, comprising;
(i) computer code for controllably navigating an ascent of a payload comprising a data collection device to a range of pre-determined altitude using a lighter than air (LTA) vehicle;
(ii) computer code for deploying the payload at the range of pre-determined altitude and a ground location and collecting data;
iii) computer code for navigating the LTA vehicle at the float altitude above the ground location for a period of time sufficient to collect the data; and
(iii) computer code for controlling a descent of the LTA vehicle from the float altitude to a recovery location using a descent vehicle.

17. The non-transient computer readable medium as recited in claim 16, wherein the LTA ascent vehicle comprises a processor used for executing the (i) computer code for navigation.

18. The non-transient computer readable medium as recited in claim 16, wherein the payload comprises a processor used for executing the (ii) computer code for deploying and collecting data.

19. The non-transient computer readable medium as recited in claim 16, wherein the descent vehicle comprises a processor used for executing the (iii) computer code for controlling the descent of the payload.

20. The non-transient computer readable medium as recited in claim 16, wherein the LTA ascent vehicle comprises a positive buoyancy balloon and a negative buoyancy balloon each having a buoyancy adjustment system being controllable by the (i) computer code for navigating the ascent of the payload.
